(19) United States
(12) Patent Application Publication
(10) Pub. No.: US 2021/0373818 A1
(43) Pub. Date: Dec. 2, 2021

(54) DEVICE MANAGEMENT SYSTEM, SERVER, MANAGEMENT APPARATUS, AND STORAGE MEDIUM

(71) Applicant: Seiko Epson Corporation, Tokyo (JP)

(72) Inventor: Yuki YAMADA, Shiojiri-shi (JP)

(21) Appl. No.: 17/335,234

(22) Filed: Jun. 1, 2021

(30) Foreign Application Priority Data
Jun. 2, 2020 (JP) 2020-095924

(51) Int. Cl. G06F 3/12

(52) U.S. Cl. CPC G06F 3/1219; G06F 3/1239; G06F 3/1232; G06F 3/1203

(57) ABSTRACT

A management system including a management server, and a terminal device including a display unit. The management server receives first operating information from a printer to be managed. The terminal device displays, on the display unit, first screen information based on the first operating information, and, in response to an operation based on the first screen information, requests the management server to acquire information. The management server provides a demand for second operating information to the printer according to the request from the terminal device, and receives the second operating information transmitted by the printer in response to the demand. The terminal device displays, on the display unit, second screen information based on the second operating information received by the management server.

The present application is based on, and claims priority from JP Application Serial Number 2020-095924, filed Jun. 2, 2020, the disclosure of which is hereby incorporated by reference herein in its entirety.

### BACKGROUND

### 1. Technical Field

The present disclosure relates to a device management system, a server, a management apparatus, and a storage medium.

### 2. Related Art

A system in which operating information of devices is collected by a server is known in the art (for example, see JP-A-2019-028756). In the system described in JP-A-2019-028756, a server collects operating information from printers and causes a portable terminal device to display the operating information.

To finely manage the operating states of devices, it is desirable to collect the operating information at short periodic intervals. However, this collection has a problem in that the processing load and communication load of a server increase as the frequency of information transmission increases.

### SUMMARY

According to an aspect of the present disclosure, there is provided a device management system including a server, and a terminal device including a display unit. The server receives first operating information from a device to be managed. The terminal device displays, on the display unit, first screen information based on the first operating information, and, in response to an operation based on the first screen information, requests the server to acquire information. According to the request from the terminal device, the server provides a demand for second operating information to the device and receives the second operating information transmitted by the device in response to the demand. The terminal device displays, on the display unit, second screen information based on the second operating information received by the server.

According to another aspect of the present disclosure, there is provided a server including a server communication unit and a server controller. The server communication unit communicates with a terminal device including a display unit, and a device to be managed. The server controller receives first operating information from the device, transmits, to the terminal device, information for the terminal device to display first screen information based on the first operating information, receives a request for acquiring information transmitted by the terminal device in response to an operation based on the first screen information, provides a demand for second operating information to the device according to the request from the terminal device, receives the second operating information transmitted by the device in response to the demand, and transmits, to the terminal device, information for the terminal device to display second screen information based on the second operating information.

According to still another aspect of the present disclosure, there is provided a management apparatus including a display unit, a terminal communication unit that communicates with a server, and a terminal controller. The terminal controller displays, on the display unit, first screen information based on first operating information received by the server from a device to be managed, in response to an operation based on the first screen information, requests the server to acquire information, and displays, on the display unit, second screen information based on second operating information transmitted to the server by the device according to the request.

According to still another aspect of the present disclosure, there is provided a non-transitory computer-readable storage medium storing a program executable by a controller that controls a management apparatus including a display unit and a terminal communication unit that communicates with a server. The program includes displaying, on the display unit, first screen information based on first operating information received by the server from a device to be managed, in response to an operation based on the first screen information, requesting the server to acquire information, and displaying, on the display unit, second screen information based on second operating information transmitted to the server by the device according to the request.

### BRIEF DESCRIPTION OF THE DRAWINGS

FIG. 1 is a diagram illustrating a configuration of a management system.

FIG. 2 is a schematic diagram of information transmitted and received in the management system.

FIG. 3 is a block diagram of a printer.

FIG. 4 is a sequence diagram illustrating operations of a device management system.

FIG. 5 is a sequence diagram illustrating operations of the device management system.

FIG. 6 is a sequence diagram illustrating operations of the device management system.

FIG. 7 is a diagram depicting an example of a screen displayed by a terminal device.

FIG. 8 is a diagram depicting another example of the screen displayed by the terminal device.

### DESCRIPTION OF EXEMPLARY EMBODIMENTS

Hereinafter, an embodiment in which the present disclosure is applied will be described with reference to the accompanying drawings.

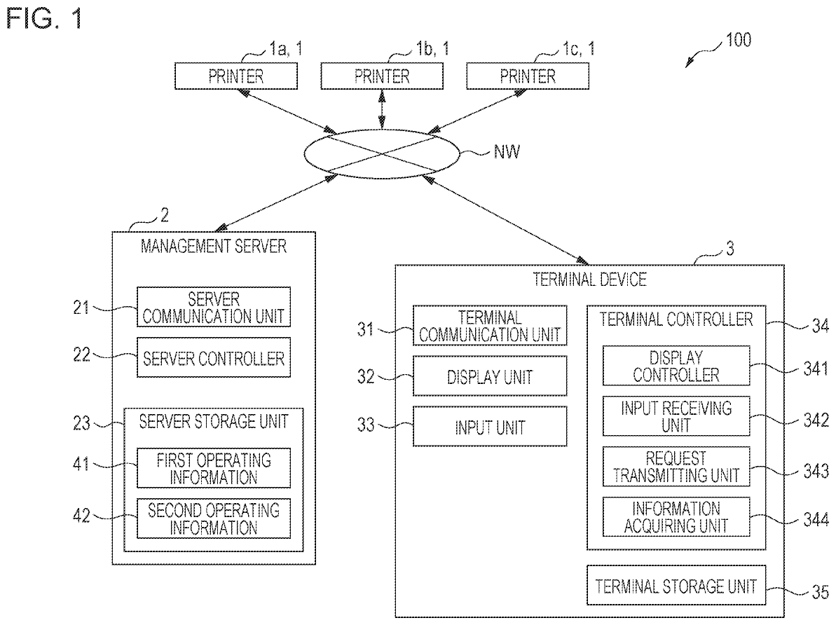

FIG. 1 is a diagram illustrating a configuration of a management system 100. The management system 100 is a device management system that manages a printer 1, which is a device to be managed. The management system 100 includes one or more printers 1, a management server 2, a terminal device 3, and a network NW that connects these devices. In the present embodiment, by way of example, a configuration in which three printers 1a, 1b, and 1c are coupled to the management server 2 is described. Hereinafter, the printers 1a, 1b, and 1c may be collectively referred to as the printers 1 when they are not discriminated from one another.

The network NW is a data communication network that communicatively connects the printers 1, the management server 2, and the terminal device 3 to each other. The network NW is composed of an Internet communication network and a LAN. The network NW may include network devices (not illustrated), such as a gateway server, a router, and a switch, and may also include a wireless communication network. LAN is the abbreviation for Local Area Network.

The printer 1 acquires print job data from a host computer (not illustrated) and executes the print job. The print job data includes image data of an image to be printed, the number of copies, various setting values regarding printing, and so on. The print job is a sequence of operations in which, according to the print job data, printing on a printing medium is performed the number of times specified in the print job data.

The printing method used by the printer 1 is arbitrary, and the printer 1 may be a serial dot impact printer or may be a laser printer. In the present embodiment, a description is given of an example in which the printer 1 is an ink jet printer and performs printing by discharging ink from an ink jet print head onto a printing medium. The printer 1 stores ink in an ink container, such as an ink tank or an ink cartridge, and supplies ink from the ink container to the print head. The printing medium used in the printer 1 include paper and cloth, but may be a sheet made of synthetic resin. The shape of the printing medium may be sheets cut to a given size or may be a long continuous sheet. In the present embodiment, an example in which a long sheet of printing paper wound in a roll is used as the printing medium is described.

The printer 1 according to the present embodiment has a sleep function, which causes the printer 1 to enter a sleep state to save power when the printer 1 is not operated for a given period of time.

The printer 1 according to the present embodiment performs a cleaning process to inhibit nozzles in the print head from clogging. The cleaning process is performed when an instruction for cleaning is received from the user, when nozzle clogging is detected, or routinely. The printer 1 performs a flushing operation and an ink suction operation as the cleaning process. The flushing operation is an operation of forcibly extracting ink from nozzles during the non-operating condition. The ink suction operation is an operation of suctioning ink from nozzles by using a suction device. The printer 1 performs the cleaning process at different intensities according to a user instruction or in accordance with the clogging state of nozzles. For example, in the flushing operation, the amount of discharged ink, the number of times ink is discharged, and so on differ depending on the intensity. In the ink suction operation, the amount of suctioned ink, the suction force, the number of times suction is carried out, and so on differ depending on the intensity.

The management server 2 is a server that performs data communication with each of the printers 1a, 1b, and 1c and manages the printers 1a, 1b, and 1c.

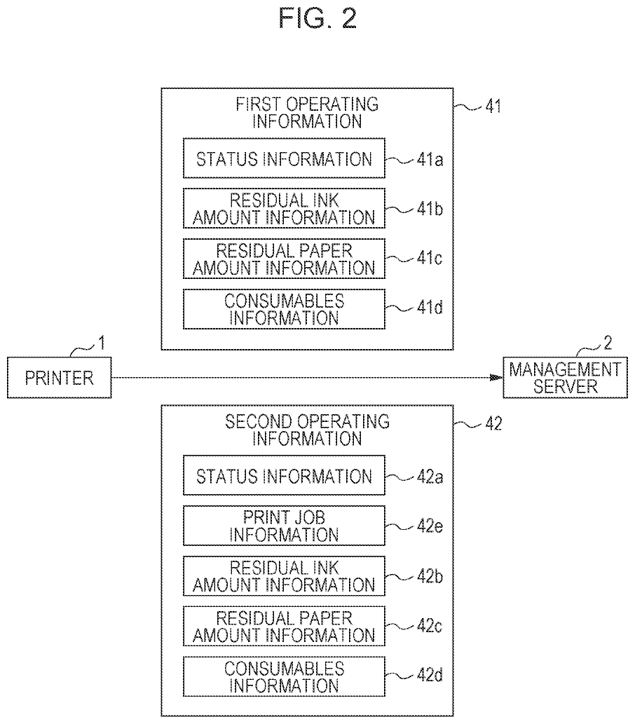

FIG. 2 is a schematic diagram of information transmitted and received in the management system 100.

The printer 1 transmits first operating information 41 and second operating information 42 to the management server 2. The first operating information 41 includes, for example, status information 41a, residual ink amount information 41b, residual paper amount information 41c, and consumables information 41d. The status information 41a is information indicating the operating state of the printer 1. The residual ink amount information 41b is information indicating the residual amount of ink stored in the printer 1, or, in other words, the amount of usable ink in the printer 1. The residual paper amount information 41c is information indicating the residual amount of paper sheets set in the printer 1. The consumables information 41d is information indicating the residual amount of consumables in the printer 1, except for ink and paper sheets.

The second operating information 42 includes, for example, status information 42a, residual ink amount information 42b, residual paper amount information 42c, consumables information 42d, and print job information 42e. The residual ink amount information 42b is information indicating the residual amount of ink stored in the printer 1. The residual paper amount information 42c is information indicating the residual amount of paper sheets set in the printer 1. The consumables information 42d is information indicating the residual amount of consumables in the printer 1, except for ink and paper sheets. The print job information 42e is information about print jobs being executed by the printer 1 and print jobs executed in the past. For example, the print job information 42e includes information about the print quantity specified in print job data, the scheduled completion time for a print job, a host computer that has transmitted the print job, and so on.

The second operating information 42 is more detailed than the first operating information 41. For example, if an error has occurred in the printer 1a, the status information 41a includes information indicating that the error has occurred. In contrast, the status information 42a includes information identifying the type of the error, the cause of the error, and a structure where the error has occurred.

For example, the residual ink amount information 41b and the residual ink amount information 42b are each information indicating the residual amount of ink of the printer 1 expressed as a percentage, assuming that the full amount is 100%. In this case, the residual ink amount information 42b is information indicating the residual ink amount in more detailed units than the residual ink amount information 41b. Specifically, the residual ink amount information 41b includes information indicating the residual ink amount in increments of 5% for each color of ink used in the printer 1. In contrast, the residual ink amount information 42b includes information indicating the residual ink amount in increments of 1% for each ink color.

For example, the residual paper amount information 41c is information indicating the residual amount of all the paper sheets set in the printer 1. Specifically, when a plurality of types of paper sheets are set in the printer 1, the residual paper amount information 41c is information indicating the residual amount obtained by totaling the residual amounts of the plurality of types of paper sheets. In contrast, the residual paper amount information 42c is information indicating the residual amount of each type of paper sheets. The residual paper amount information 41c and the residual paper amount information 42c each indicate the residual amount of paper sheets, for example, expressed as a percentage, assuming that the maximum amount that can be set in the printer 1 is 100%. Here, the residual paper amount information 41c may be information indicating the residual amount of paper sheets in larger units than the residual paper amount information 42c. Specifically, the residual paper amount information 41c may be information indicating the residual amount of paper sheets in increments of 5%, and the residual paper amount information 42c may be information indicating the residual amount of paper sheets in units of 1%.

The consumables information 41d and the consumables information 42d each include information indicating the residual amount of consumables used in the printer 1. For example, the residual amount of consumables is expressed as a percentage, assuming that the maximum amount that can be set in the printer 1 is 100%. The consumables information 41d may be information indicating the residual amount of consumables in larger units than the consumables information 42d. Specifically, the consumables information 41d may be information indicating the residual amount of consumables in increments of 5%, and the consumables information 42d may be information indicating the residual amount of consumables in units of 1%.

The printer 1 transmits the first operating information 41 at a preset timing. For example, at each preset time, the printer 1 detects the operating state of the printer 1 and the residual amounts of ink and the like, generates the first operating information 41, and transmits the first operating information 41 to the management server 2. The printer 1 also transmits the first operating information 41 each time a preset condition is satisfied. Specifically, after transmitting the first operating information 41, the printer 1 transmits the next first operating information 41 when the residual amount of ink is decreased by a predetermined amount.

The management server 2 may demand that the printer 1 transmit the second operating information 42. When the management server 2 demands that the printer 1 transmit the second operating information 42, the printer 1 generates and transmits the second operating information 42 in response to the demand.

Thus, the management server 2 may manage the operating state of the printer 1 by means of the first operating information 41. The management server 2 may also manage the operating state of the printer 1 in more detail by means of information that is more detailed than the first operating information 41, and/or the second operating information 42 including the print job information 42e, which is not included in the first operating information 41.

Referring back to FIG. 1, the management server 2 includes a server communication unit 21, a server controller 22, and a server storage unit 23. The server communication unit 21 includes a wired communication interface circuit or a wireless communication module and performs data communication with the printers 1 and the terminal device 3 over the network NW in compliance with control of the server controller 22.

Using a control program executed by a processor, such as a CPU, the server controller 22 controls the units of the management server 2 through cooperation of software and hardware. The server controller 22 controls the server communication unit 21 to perform communication with the printers 1 so as to cause the server communication unit 21 to receive the first operating information 41 transmitted by the printers 1, to demand that the printers 1 transmit the second operating information 42, and to receive the second operating information 42. The server controller 22 causes the server storage unit 23 to store the first operating information 41 and the second operating information 42 received by the server communication unit 21. The server controller 22 may include a RAM, which forms a work area, and a ROM, in which the control program is stored, in addition to the processor, or may be an integrated device in which these components are integrated. Additionally, the server controller 22 may include a plurality of processors. CPU is the abbreviation for Central Processing Unit, RAM is the abbreviation for Random-Access Memory, and ROM is the abbreviation for Read-Only Memory.

The server storage unit 23 is a storage device that stores data in a nonvolatile manner. The server storage unit 23 stores the first operating information 41 and the second operating information 42 in association with each printer 1 in compliance with control of the server controller 22. For example, the first operating information 41 transmitted by the printer 1a, the first operating information 41 transmitted by the printer 1c, and the first operating information 41 transmitted by the printer 1c are stored such that they are distinguishable from each other in the server storage unit 23.

The terminal device 3 is a management device used by an operator who manages the printer 1, and is constituted by a personal computer, a tablet computer, a smartphone, or the like. The terminal device 3 includes a display panel, such as a liquid crystal display panel, and displays screens based on the first operating information 41 and the second operating information 42. To perform the display, the terminal device 3 communicates with the management server 2 to acquire the first operating information 41 and the second operating information 42 stored in the management server 2.

The terminal device 3 includes a terminal communication unit 31, a display unit 32, an input unit 33, a terminal controller 34, and a terminal storage unit 35. The terminal communication unit 31 includes a wired communication interface circuit or a wireless communication module and performs data communication with the management server 2 over the network NW in compliance with control of the terminal controller 34.

The display unit 32 displays characters and images on a display panel in compliance with control of the terminal controller 34. The display unit 32 according to the present embodiment displays a list screen 60 or a detailed display screen 70 described later.

The input unit 33 receives an input operation performed by the operator. The input unit 33 includes various switches (not illustrated) mounted in the housing of the terminal device 3 and/or a touch sensor superimposed on the display panel of the display unit 32. The input unit 33 detects an operation and outputs data indicating the detected operation to the terminal controller 34.

Using a control program executed by a processor, such as a CPU, the terminal controller 34 controls the units of the terminal device 3 through cooperation of software and hardware. The terminal controller 34 may include a RAM, which forms a work area, and a ROM, in which the control program is stored, in addition to the processor, or may be an integrated device in which they are integrated. The terminal controller 34 may also include a plurality of processors. The program that is executed by the terminal controller 34 may be stored in the terminal storage unit 35. The terminal storage unit 35 is a storage device that stores data that is processed by the terminal controller 34 and programs that are executed by the terminal controller 34, in a non-volatile manner. The programs stored in the terminal storage unit 35 are programs executable by a processor of the terminal controller 34, that is, a computer.

The terminal controller 34 includes a display controller 341, an input receiving unit 342, a request transmitting unit 343, and an information acquiring unit 344. These function units are implemented by the functions of the control program described above.

The display controller 341 generates display information for displaying the list screen 60 based on the first operating information 41 received by the terminal communication unit 31, and causes the display unit 32 to display the list screen 60. The display controller 341 also generates display information for displaying the detailed display screen 70 based on the second operating information 42 received by the terminal communication unit 31, and causes the display unit 32 to display the detailed display screen 70. The list screen 60 corresponds, by way of example, to the first screen information, and the detailed display screen 70 corresponds, by way of example, to the second screen information.

The input receiving unit 342 receives input content corresponding to an operation detected by the input unit 33.

According to the input received by the input receiving unit 342, the request transmitting unit 343 requests the management server 2 to acquire and/or transmit the second operating information 42.

The information acquiring unit 344 causes the terminal communication unit 31 to receive the first operating information 41 transmitted by the management server 2, thereby acquiring the first operating information 41. The information acquiring unit 344 causes the terminal communication unit 31 to receive the second operating information 42 transmitted by the management server 2, thereby acquiring the second operating information 42. The information acquiring unit 344 may temporarily store the acquired first operating information 41 and second operating information 42 in the terminal storage unit 35.

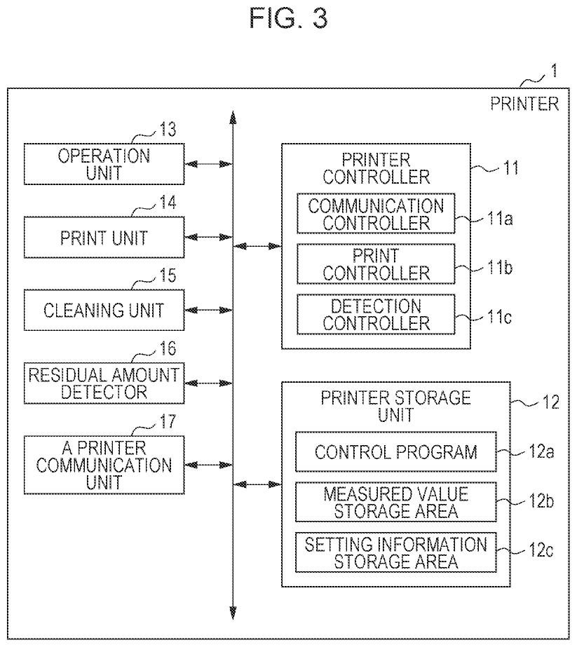

FIG. 3 is a block diagram illustrating the printer 1. The printer 1 includes a printer controller 11, a printer storage unit 12, an operation unit 13, a print unit 14, a cleaning unit 15, a residual amount detector 16, and a printer communication unit 17.

The operation unit 13 includes operating pieces (not illustrated), such as switches and buttons, or a touch sensor superimposed on a display screen, and the like and detects an operation performed by the operator. The operation unit 13 outputs data indicating the detected operation to the printer controller 11.

The print unit 14 includes various mechanisms (not illustrated), such as a print head that discharges ink, a head drive mechanism that drives the print head, a transport mechanism that transports paper sheets as a printing medium, and various mechanisms (not illustrated). The printing unit 14 performs printing on the paper sheets in compliance with control of the printer controller 11.

The cleaning unit 15 performs the cleaning process. As mentioned above, the cleaning process includes the flushing operation and the ink suction operation.

The residual amount detector 16 detects the residual amounts of ink, paper sheets, and the other consumables of the printer 1. The residual amount detector 16 includes, for example, an optical sensor that detects the residual amount of ink stored in an ink container, such as an ink tank or an ink cartridge, and an optical sensor or a switch sensor that detects the residual amount of print sheets. The detected value of the residual amount detector 16 may be acquired at any time by the printer controller 11.

The printer communication unit 17 includes a wired communication interface circuit or a wireless communication module and performs data communication with the management server 2 over the network NW in compliance with control of the printer controller 11.

Using a control program 12a described later executed by a processor, such as a CPU or an ASIC, the printer controller 11 controls the units of the printers 1 through cooperation of software and hardware. The printer controller 11 may include a RAM, which forms a work area, and a ROM, in which the control program is stored, in addition to the processor, or may be an integrated device in which these components are integrated. ASIC is the abbreviation for Application Specific Integrated Circuit.

The printer storage unit 12 is a nonvolatile storage device for storing programs that are executed by a processor of the printer controller 11 and data that is processed by the printer controller 11. The printer storage unit 12 stores the control program 12a and includes a measured value storage area 12b and a setting information storage area 12c.

The printer controller 11 includes a communication controller 11a, a print controller 11b, and a detection controller 11c. These function units are each implemented when the printer controller 11 executes the control program 12a.

The communication controller 11a controls the printer communication unit 17, so that the printer communication unit 17 performs data communication with the management server 2. The communication controller 11a receives a demand for the second operating information 42 transmitted by the management server 2. The communication controller 11a transmits the first operating information 41 and the second operating information 42 to the management server 2.

The print controller 11b controls the print unit 14 so that the print unit 14 performs printing, according to print job data received from the host computer (not illustrated). The print controller 11b causes the cleaning process to be performed by the cleaning unit 15 when a predetermined condition is satisfied.

The detection controller 11c acquires the residual amounts of ink and paper sheets detected by the residual amount detector 16 and causes the acquired values to be stored in the measured value storage area 12b. The detection controller 11c performs detection for the operating state and the like of the print unit 14 or acquires information about the operating state and the like. The detection controller 11c generates the first operating information 41 and the second operating information 42 from the acquired information. The first operating information 41 and the second operating information 42 generated by the detection controller 11c are transmitted to the management server 2 through control of the communication controller 11a.

The setting information storage area 12c included in the printer storage unit 12 stores information for setting operations of the printer 1, such as information for setting a timing at which the detection controller 11c acquires the detected value of the residual amount detector 16.

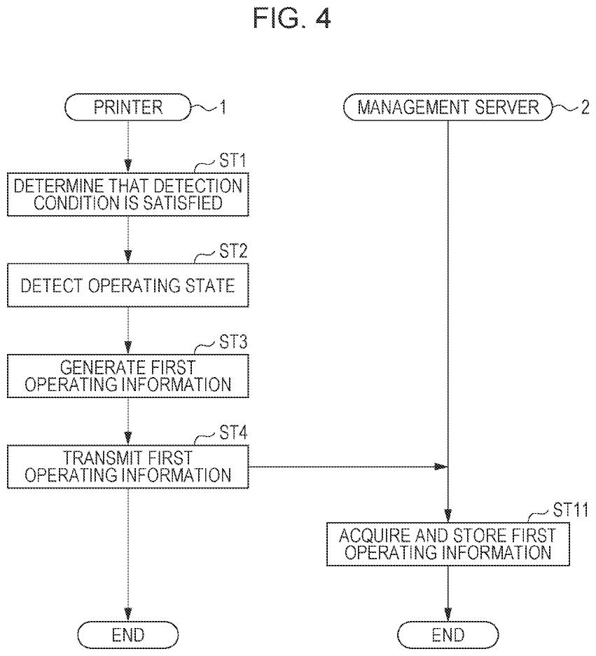

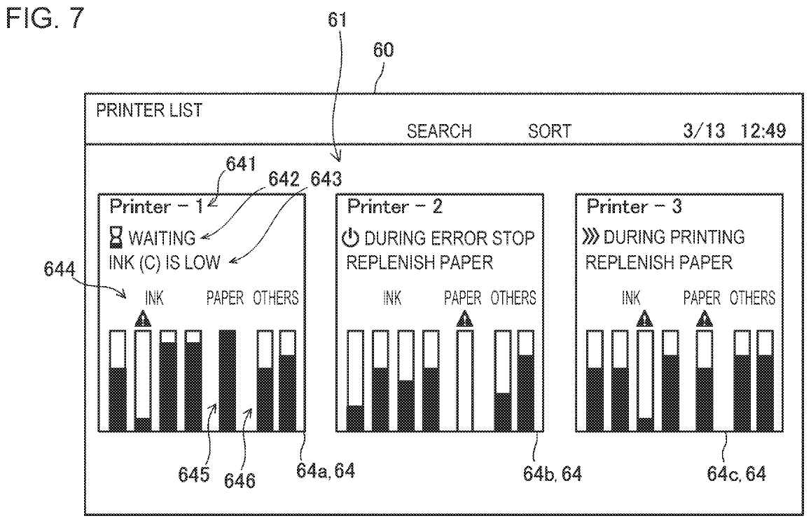

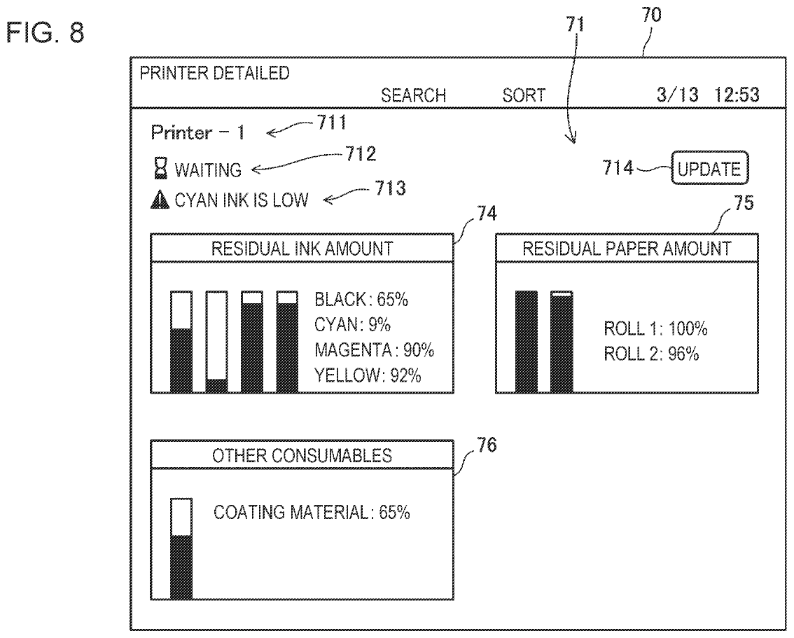

FIGS. 4, 5, and 6 are sequence diagrams illustrating operations of the management system 100. FIG. 7 is a diagram depicting an example of a screen displayed on the terminal device 3, and depicts the list screen 60. FIG. 8 is a diagram depicting another example of a screen displayed on the terminal device 3, and depicts the detailed display screen 70.

With reference to these figures, the operations of the management system 100 will now be described.

FIG. 4 illustrates operations of the printer 1 and the management server 2.

When a predetermined detection condition is satisfied (step ST1), the printer controller 11 detects the operating state of the printer 1 (step ST2). In step ST2, the residual amounts of ink, paper sheets, and other consumables are detected.

The printer 1 generates the first operating information 41 based on a result detected in step ST2 (step ST3) and transmits the first operating information 41 to the management server 2 (step ST4).

The management server 2 receives the first operating information 41 with the server communication unit 21, and the server controller 22 acquires the first operating information 41 and stores the first operating information 41 in the server storage unit 23 (step ST11).

The detection condition in step ST1 is, for example, that a period of time set in advance in the printer 1 has elapsed. In this case, after every lapse of the period of time, the printer controller 11 detects the operating state of the printer 1 and generates the first operating information 41.

The printer controller 11 may also perform an operation of acquiring a detected value of the residual value detector 16 every given period of time, and determine that the detection condition in step ST1 is satisfied if the variation in the detected value of the residual value detector 16 exceeds a set threshold. The periodic interval at which the detection controller 11c acquires a detected value of the residual amount detector 16 and the threshold for variations in the detected value of the residual value detector 16 are stored in the setting information storage area 12c.

Each time the detection condition is satisfied in step ST1, the operations illustrated in FIG. 4 are executed and the first operating information 41 stored in the server storage unit 23 is updated. That is, the latest first operating information 41 is stored in the server storage unit 23.

The operations in FIG. 4 are executed by each printer 1 coupled to the management server 2 and the management server 2, and thereby the first operating information 41 received from each of the printers 1a, 1b, and 1c is individually stored in the server storage unit 23.

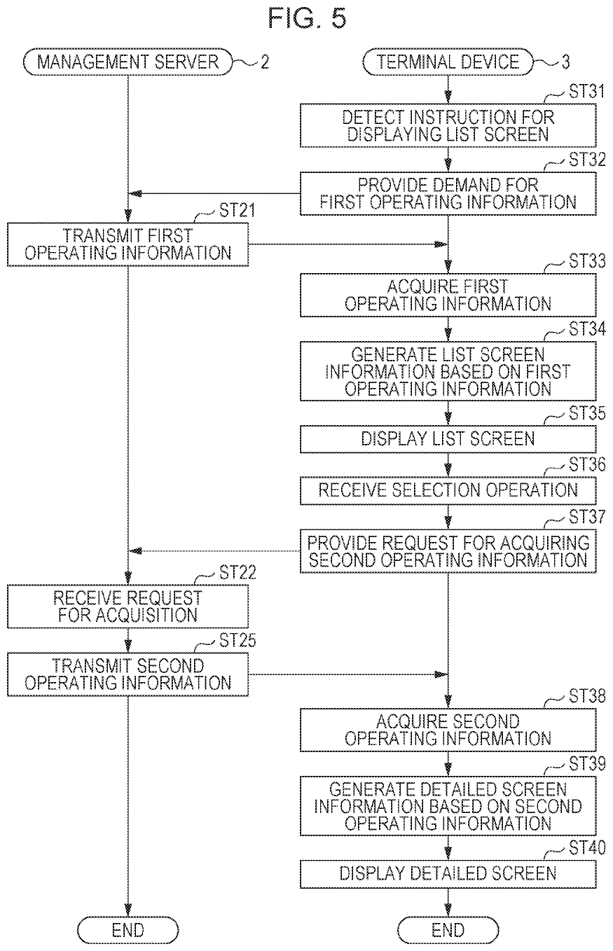

FIG. 5 illustrates operations of the management server 2 and the terminal device 3.

The terminal controller 34 detects an instruction to display the list screen issued by an operation of the operator (step ST31) and demands that the terminal device 3 transmit the first operating information 41 (step ST32).

In response to the demand from the terminal device 3, the server controller 22 transmits the first operating information 41 related to a plurality of printers 1 to the terminal device 3 (step ST21).

Using the terminal communication unit 31, the terminal controller 34 receives and acquires the first operating information 41 transmitted by the management server 2 (step ST33). The terminal controller 34 generates list screen information based on the acquired first operating information 41 (step ST34) and displays, on the display unit 32, the list screen 60 based on the list screen information (step ST35).

FIG. 7 depicts an example of the list screen 60.

In the example depicted in FIG. 7, the list screen 60 includes an information display area 61 for displaying a list of the content of the first operating information 41 about the printers 1a, 1b, and 1c coupled to the management server 2. The information display area 61 includes an operating information display area 64a that displays the content of the first operating information 41 indicating the operating state of the printer 1a, an operating information display area 64b that displays the content of the first operating information 41 indicating the operating state of the printer 1b, and an operating information display area 64c that displays the content of the first operating information 41 indicating the operating state of the printer 1c. The operating information display areas 64a, 64b, and 64c may be collectively referred to as the operating information display areas 64.

The operating information display area 64a includes a printer name display area 641, a status display area 642, a warning display area 643, a residual ink amount display area 644, a residual paper amount display area 645, and a residual consumables amount display area 646.

The printer name display area 641 displays information capable of identifying the printer 1a, such as the name, unique identification information, and number of the printer 1a. These information items are included in, for example, the first operating information 41 that the printer 1a transmits. The status display area 642 displays the status of the printer 1a. The warning display area 643 displays a warning about the operating state of the printer 1a. The status display area 642 and the warning display area 643 display, for example, the content of the status information 41a, and, in the example in FIG. 7, a warning is displayed saying that the residual amount of cyan ink is low.

The residual ink amount display area 644 displays, for each ink color, the residual amount of ink of the printer 1a. The display of the residual ink amount display area 644 corresponds to the residual ink amount information 41b. For the display in the residual ink amount display area 644, instead of numerical values representing the residual amounts, graphics, such as bar graphs as depicted in FIG. 7, are desirable. In the residual ink amount display area 644, the residual amounts of ink are represented in round figures, allowing the operator to roughly determine the residual amount of ink. For example, the bar graph depicted in FIG. 7 reflects the residual amounts of ink in increments of 5%.

The residual paper amount display area 645 displays the total residual amount of all the paper sheets set in the printer 1a. The display of the residual paper amount display area 645 corresponds to, for example, the residual paper amount information 41c. For the display in the residual paper amount display area 645, instead of a numerical value representing the residual amount, a graphic, such as a bar graph as depicted in FIG. 7, is desirable. In the residual paper amount display area 645, the residual amount of paper sheets is represented in round figures, allowing the operator to roughly determine the residual amount of paper sheets. For example, the bar graph depicted in FIG. 7 reflects the total residual amount of paper sheets in increments of 5%.

The residual consumables amount display area 646 displays, for example, the residual amount of consumables, such as a coating material that is discharged onto a paper sheet to which ink adheres such that the coating material covers the ink. The display of the residual consumables amount display area 646 corresponds to, for example, the consumables information 41d. For the display in the residual consumables amount display area 646, use of a graphic is desirable as in the residual ink amount display area 644 and the residual paper amount display area 645.

For the printer 1b and the printer 1c, the information display area 61 displays the content of the first operating information 41 in the same manner as for the printer 1a.

The information displayed in the status display area 642, the warning display area 643, the residual ink amount display area 644, the residual paper amount display area 645, and the residual consumables amount display area 646 is a visualized form of information included in the first operating information 41.

With the list screen 60 being displayed, the operator may perform an operation on the terminal device 3 to select any of the operating information display areas 64. When wanting to know in detail the operating state of the printer 1a, the operator selects the operating information display area 64a. Likewise, when wanting to know in more detail the operating state of the printer 1b, the operator selects the operating information display area 64b, and when wanting to know in detail the operating state of the printer 1c, the operator selects the operating information display area 64c.

Referring back to FIG. 5, the terminal controller 34 receives a selection operation performed by the operator with the list screen 60 being displayed (step ST36). The terminal controller 34 identifies the printer 1 corresponding to the selected operating information display area 64 and transmits, to the management server 2, a request for acquiring the second operating information 42 about the identified printer 1 (step ST37).

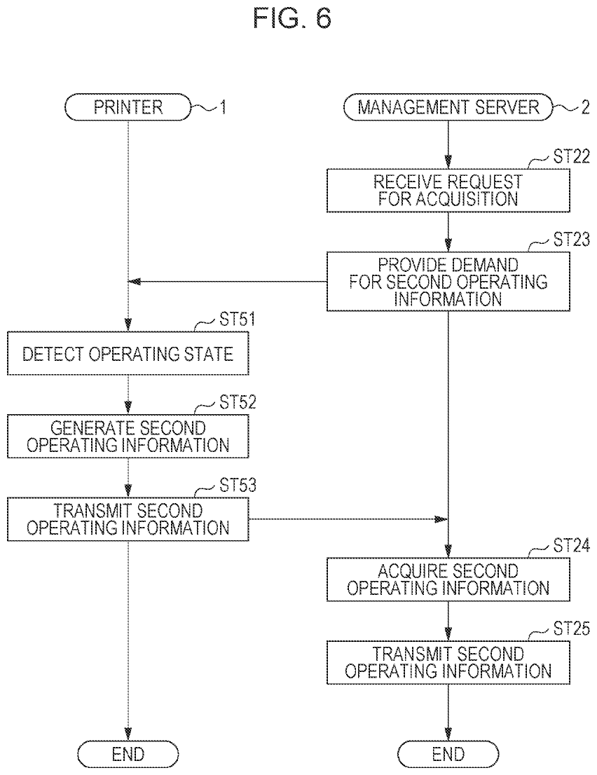

The server controller 22 receives the request for acquiring the second operating information 42 (step ST22) and performs a process of acquiring the second operating information 42. This process is illustrated in FIG. 6.

FIG. 6 illustrates operations of the printer 1 and the management server 2 related to acquisition of the second operating information 42. After receiving the acquisition request in step ST22, the server controller 22 provides a demand for the second operating information 42 to the printer 1 (step ST23). In step ST23, the server controller 22 transmits the demand to a single printer 1 corresponding to the operating information display area 64 selected by the operator.

In response to the demand from the management server 2, the printer controller 11 detects an operating state (step ST51). In step ST51, the printer controller 11 detects information to be used for generating the second operating information 42. Therefore, in step ST51, the processing may be similar to that in step ST2, but detection of more items and/or detection with more precision may be performed than in step ST2.

The printer controller 11 generates the second operating information 42 based on a result detected in step ST51 (step ST52) and transmits the generated second operating information 42 to the management server 2 (step ST53).

The server controller 22 acquires the second operating information 42 transmitted by the printer 1 (step ST24) and stores the acquired second operating information 42 in the server storage unit 23. The server controller 22 transmits the acquired second operating information 42 to the terminal device 3 (step ST25).

Referring back to FIG. 5, the terminal controller 34 acquires the second operating information 42 transmitted by the management server 2 (step ST38) and generates detailed screen information based on the second operating information 42 (step ST39). The terminal controller 34 displays, on the display unit 32, the detailed display screen 70 based on the detailed screen information (step ST40).

FIG. 8 depicts an example of a configuration of the detailed display screen 70.

In the example depicted in FIG. 8, the detailed display screen 70 displays the content of the second operating information 42 about one printer 1 among the printers 1a, 1b, and 1c coupled to the management server 2. FIG. 8 depicts an example in which the second operating information 42 of the printer 1a is displayed.

The detailed display screen 70 includes information display area 71 that displays the content of the second operating information 42. The information display area 71 includes a printer name display area 711, a status display area 712, and a warning display area 713, and information displayed in the areas 711 to 713 corresponds to, for example, the status information 42a. Information displayed in the printer name display area 711, the status display area 712, and the warning display area 713 may either be the same information as in the printer name display area 641, the status display area 642, and the warning display area 643, respectively, or may be more detailed information.

Although not depicted in FIG. 8, the content of the print job information 42e may be displayed in the information display area 71.

The ink display area 71 includes a residual ink amount display area 74, a residual paper amount display area 75, and a residual consumables amount display area 76. The residual ink amount display area 74 displays, for each ink color, the residual amount of ink of the printer 1a. The display of the residual ink amount display area 74 includes detailed numerical values representing residual ink amounts and a graphic, such as a bar graph indicating numerical values. It is desirable that the graphic in the residual ink amount display area 74 be displayed more finely than the graphic in the residual ink amount display area 644. The display in the residual ink amount display area 74 corresponds to, for example, the residual ink amount information 42b.

The residual paper amount display area 75 displays the residual amount of paper sheets set in the printer 1a for each type of paper sheets or for each location at which paper sheets are set. FIG. 8 depicts an example in which two rolls of paper sheets may be set in the printer 1a, and the residual amount of each of the two rolls is individually displayed in the residual paper amount display area 75. The residual paper amount display area 75 displays numerical values representing the residual amounts of paper sheets and a graphic, such as a bar graph, indicating the residual amounts of paper sheets. It is desirable that the graphic in the residual paper amount display area 75 be displayed at finer scales than the graphic in the residual paper amount display area 645. The display in the residual paper amount display area 75 corresponds to, for example, the residual paper amount information 42c.

The residual consumables amount display area 76 displays the residual amount of consumables, such as a coating material that is discharged onto a paper sheet to which ink adheres such that the coating material covers the ink. For the case where a plurality of types of consumables other than ink and paper sheets are used in the printer 1a, the residual consumables amount display area 76 displays the residual amount of each type of consumables by using numerical values and a graphic. It is desirable that the graphic in the residual consumables amount display area 76 be displayed at finer scales than the graphic in the residual consumables amount display area 646. The display in the residual consumables amount display area 76 corresponds to, for example, the consumables information 42d.

The detailed display screen 70 includes an update button 714. The update button 714 is a button indicating update of information displayed in the detailed display screen 70. When the update button 714 is operated, the terminal controller 34 provides the demand in step ST33 again. This updates the detailed display screen 70 so that the detailed display screen 70 reflects the latest operating state of the printer 1a.

With the detailed display screen 70 being displayed, an operation performed by the operator allows the terminal controller 34 to return to the display of the list screen 60. With the list screen 60 being displayed, when any of the operating information display areas 64a, 64b, and 64c is selected by the operator, the terminal controller 34 executes operations of step ST36 and the subsequent steps.

In this way, an operator who operates the terminal device 3 may recognize the operating states of the plurality of printers 1, which are coupled to the management server 2, using the list screen 60. By selecting the printer 1 to cause the detailed display screen 70 to be displayed, the operator may recognize the more detailed operating state for the selected printer 1.

The details of processing related to the displays of the list screen 60 and the detailed display screen 70 may be configured in any manner. For example, the configuration may be such that the terminal controller 34 executes a Web browser and the server controller 22 functions as a Web server. In this case, the sever controller 22 may generate data of a Web page for displaying the list screen 60 based on the first operating information 41 and transmit the data to the terminal device 3. If an operation of issuing an instruction for displaying the detailed display screen 70 is performed while the Web browser of the terminal controller 34 displays the list screen 60, this operation triggers the terminal device 3 to request the management server 2 to acquire information. That is, notification of an instruction for displaying the detailed display screen 70 from the terminal device 3 to the management server 2 corresponds to the request for acquiring information. The server controller 22 may acquire the second operating information 42 in response to the request from the terminal controller 34, generate data of a Web page for displaying the detailed display screen 70 based on the second operating information 42, and transmit the data to the terminal device 3. The server controller 22 may also provide a Web application that runs in a Web browser. In this case, the terminal controller 34 may execute the Web application to form a Web page including the list screen 60, by using the first operating information 41 provided by the management server 2 or information extracted from the first operating information 41 by the server controller 22, and display the Web page. The terminal controller 34 may also execute the Web application to form a Web page including the detailed display screen 70, by using the second operating information 42 provided by the management server 2 or information extracted from the second operating information 42 by the server controller 22, and display the Web page.

As described above, the management system 100 according to the present embodiment includes the management server 2 and the terminal device 3 including the display unit 32. The management server 2 receives the first operating information 41 from the printer 1 to be managed. The terminal device 3 displays, on the display unit 32, the list screen 60 based on the first operating information 41 and, in response to an operation based on the list screen 60, requests the management server 2 to acquire information. According to the request from the terminal device 3, the management server 2 provides a demand for the second operating information 42 to the printer 1, and receives the second operating information 42 transmitted by the printer 1 in response to the demand. The terminal device 3 displays, on the display unit 32, the detailed display screen 70 based on the second operating information 42 received by the management server 2.

The management server 2 according to the embodiment described above includes the server communication unit 21, which communicates with the terminal device 3 including the display unit 32 and the printer 1 to be managed, and the serer controller 22. The server controller 22 receives the first operating information 41 from the printer 1, transmits, to the terminal device 3, information for the terminal device 3 to display the list screen 60 based on the first operating information 41, and receives a request for acquiring information transmitted by the terminal device 3 in response to an operation based on the list screen 60. According to the request from the terminal device 3, the server controller 22 provides a demand for the second operating information 42 to the printer 1, and receives the second operating information 42 transmitted by the printer in response to the demand. The server controller 22 transmits, to the terminal device 3, information for the terminal device 3 to display the detailed display screen 70 based on the second operating information 42.

According to this configuration, the operator may recognize the operating state of the printer 1, which is a device to be managed, with the list screen 60, and the detailed display screen 70 may be displayed when finer information about the operating state of the printer 1 is to be used. Therefore, reduction in the frequency at which detailed information is transmitted from the printer 1 to the management server 2 may result in reduction in the processing load and communication load of the management server 2, enabling detailed management of the operating state.

The terminal device 3 according to the embodiment described above includes the display unit 32, the terminal communication unit 31 that communicates with the management server 2, and the terminal controller 34. The terminal controller 34 displays, on the display unit 32, the list screen 60 based on the first operating information 41 received from the printer 1 by the management server 2. In response to an operation based on the list screen 60, the terminal controller 34 requests the management server 2 to acquire information, and displays, on the display unit 32, the detailed display screen 70 based on the second operating information 42 transmitted to the management server 2 by the printer 1 according to the request.

The control program that is executed by the processor of the terminal controller 34 in the terminal device 3 displays, on the display unit 32, the list screen 60 based on the first operating information 41 received from the printer 1 by the management server 2. In response to an operation based on the list screen 60, the control program requests the management server 2 to acquire information, and displays, on the display unit 32, the detailed display screen 70 based on the second operating information 42 transmitted to the management server 2 by the printer 1 according to the request.

According to this configuration, the terminal device 3 may indicate the operating state of the printer 1, which is a device to be managed, to the operator with the list screen 60, and may display the detailed display screen 70 when finer information about the operating state of the printer 1 is to be used. Therefore, reduction in the frequency at which detailed information is transmitted from the printer 1 to the management server 2 may result in reduction in the processing load and communication load of the management server 2, enabling detailed management of the operating state.

In the embodiment described above, the terminal device 3 displays the list screen 60 in which respective pieces of the first operating information 41 transmitted by a plurality of printers 1 are displayed as a list of the printers 1. The terminal device 3 provides, to the management server 2, a request for the second operating information 42 of the printer 1 selected by using the list screen 60.

According to this configuration, with the list screen 60 being displayed, more detailed information may be quickly acquired from the printer 1, and the detailed display screen 70 may be displayed.

The first operating information 41 is transmitted at a first timing from the printer 1 to the management server 2, and the second operating information 42 is transmitted from the printer 1 to the management server 2 at a second timing in response to the demand transmitted by the management server 2.

According to this configuration, the frequency at which detailed information is transmitted from the printer 1 to the management server 2 may be reduced more effectively, and information about the operating states of the plurality printers 1 may be acquired and displayed regularly or at a high frequency.

The first operating information 41 and the second operating information 42 include information about the printers 1. The second operating information 42 includes information of a type that is not included in the first operating information 41, and/or information more detailed than the first operating information 41.

According to this configuration, the management server 2 may effectively collect information about the operating states of the printers 1 and provide the information to an operator who operates the terminal device 3.

The embodiment described above merely illustrates an aspect of the present disclosure, and any modifications and technical applications may be made within the scope and spirit of the present disclosure.

For example, the device to be managed by the management system 100 is not limited to the printers 1, and the present disclosure may be applied to a multi-function printer having a printing functionality and other various devices.

The function units illustrated in FIG. 1 and FIG. 3 are exemplary and the specific implementation forms are not limited. That is, it is unnecessary to implement hardware individually corresponding to the units. It is, of course, possible to implement the functions of the units by a single processor executing a program. In addition, some of the functions implemented by software in the embodiment described above may be hardware, or some of the functions implemented by hardware may be implemented by software.

The step units of operations illustrated in FIGS. 4 to 6 are units into which the operations of each device in the management system 100 are divided in accordance with the main processing content for the sake of easy understanding. The present disclosure is not limited by how to divide the processing units or by the names. In accordance with the processing content, the operations may be divided into more step units. The operations may also be divided such that one step unit includes more processes. The order of steps may be changed appropriately without causing an obstacle to the gist of the present disclosure.

What is claimed is:

1. A device management system comprising:
a server; and
a terminal device including a display unit, wherein the server
receives first operating information from a device to be managed,
the terminal device
displays, on the display unit, first screen information based on the first operating information, and
in response to an operation based on the first screen information, requests the server to acquire information,
the server
according to the request from the terminal device, provides a demand for second operating information to the device, and
receives the second operating information transmitted by the device in response to the demand, and
the terminal device
displays, on the display unit, second screen information based on the second operating information received by the server.

2. The device management system according to claim 1, wherein the terminal device
displays first screen information in which respective pieces of the first operating information transmitted by a plurality of the devices are displayed as a list of the devices, and
provides, to the server, a request for the second operating information of the device selected by using the first screen information.

3. The device management system according to claim 1, wherein
the first operating information is transmitted at a first timing from the device to the server, and
the second operating information is transmitted from the device to the server at a second timing in response to the demand transmitted by the server.

4. The device management system according to claim 1, wherein
the first operating information and the second operating information include information about the device, and
the second operating information includes information of a type that is not included in the first operating information, and/or information more detailed than the first operating information.

5. A server comprising:
a server communication unit that communicates with a terminal device including a display unit, and a device to be managed; and
a server controller, wherein the server controller
receives first operating information from the device,
transmits, to the terminal device, information for the terminal device to display first screen information based on the first operating information,
receives a request for acquiring information transmitted by the terminal device in response to an operation based on the first screen information,
according to the request from the terminal device, provides a demand for second operating information to the device,
receives the second operating information transmitted by the device in response to the demand, and
transmits, to the terminal device, information for the terminal device to display second screen information based on the second operating information.

6. A management apparatus comprising:
a display unit;
a terminal communication unit that communicates with a server; and
a terminal controller, wherein the terminal controller
displays, on the display unit, first screen information based on first operating information received by the server from a device to be managed,
in response to an operation based on the first screen information, requests the server to acquire information, and
displays, on the display unit, second screen information based on second operating information transmitted to the server by the device according to the request.

7. A non-transitory computer-readable storage medium storing a program executable by a controller that controls a management apparatus including a display unit and a terminal communication unit that communicates with a server, the program comprising:
displaying, on the display unit, first screen information based on first operating information received by the server from a device to be managed;
in response to an operation based on the first screen information, requesting the server to acquire information; and
displaying, on the display unit, second screen information based on second operating information transmitted to the server by the device according to the request.
